(19) United States
(12) Patent Application Publication
(10) Pub. No.: US 2019/0247743 A1
(43) Pub. Date: Aug. 15, 2019

(54) LEARNING RULER ALLOWING THREE-DIMENSIONAL PLAY

(71) Applicants: Gyeong Sun MOON, Gyeonggi-do (KR); Chun Taek YOON, Gyeonggi-do (KR)

(72) Inventors: Gyeong Sun MOON, Gyeonggi-do (KR); Chun Taek YOON, Gyeonggi-do (KR)

(21) Appl. No.: 16/336,716

(22) PCT Filed: Sep. 25, 2017
(86) PCT No.: PCT/KR2017/010519

§ 371 Date: Mar. 26, 2019

(30) Foreign Application Priority Data
Oct. 5, 2016 (KR) 20-2016-0005742

(51) Int. Cl. A63F 9/06; A63F 3/04; G09B 1/16; G09B 19/24

(52) U.S. Cl. CPC A63F 9/0666; A63F 3/0449; A63F 2003/0455; G09B 19/24; G09B 1/16

(57) ABSTRACT

A learning ruler allowing three-dimensional play, comprising: a body having a plate shape and at least one or more scales formed thereon so as to measure a length; and at least one or more stereoscopic plates formed by cutting parts of the body so as to be detachably attached to the body and to be three-dimensionally set on the top surface of the body by means of attachment means after being separated from the body.

### BACKGROUND

The present invention relates to a learning ruler allowing three-dimensional play, which can be used for measuring a length as a ruler that is stationery in a usual case and for learning with three-dimensional play in some cases.

In general, there have been developed a variety of training, teaching and learning aids and books for the brain development of infant or children with interest in learning letters, numbers, pictures and the like.

However, most existing textbooks mostly have the shape of books or cards formed of paper materials and merely suggest the learning methods that depend on visual effects by displaying letters, numbers or pictures on a simple two-dimensional plane.

This learning method leads the infants or children to acquire the contents of learning by depending on the visual effects only, thereby causing the side effect of being biased toward cramming education without inducing interest or curiosity, and have the danger of giving the infants or children an idea that learning is dry and hard despite the need to develop application ability and imagination for the infant and children who need to receive wide education gradually.

In order to solve the problems as mentioned above, stereoscopic books have been made conventionally as disclosed in registered patent No. 10-0,445,765 (25 Aug. 2004) or registered patent No. 10-0,747,690 (8 Aug. 2007). However, since such a stereoscopic book is concentrated only on education, the stereoscopic book may temporarily cause interest in pop-up parts protruding when opening the books but still have failed to provide fundamental solutions.

Furthermore, there is still another problem that such a conventional stereoscopic book is portable but cannot provide any other functions in addition to the simple function as a portable book.

### SUMMARY OF THE INVENTION

Accordingly, the present invention has been made in an effort to solve the above-mentioned problems, and it is an objective of the present invention to appropriately distribute learning and playing so that infants and children as users are not easily bored and have learning effect through playing with imagination.

There is another objective of carrying out the function as stationery in addition to the effect of playing and learning.

### TECHNICAL SOLUTION

In order to solve the technical problems as described above, a learning ruler allowing three-dimensional play according to the present invention includes a body having a plate shape and at least one or more scales formed thereon so as to measure a length, and at least one or more stereoscopic plates formed by cutting parts of the body so as to be detachably attached to the body and to be three-dimensionally set on the top surface of the body by means of attachment means after being separated from the body, wherein the stereoscopic plate is formed to be cut in the shape of at least one of a living creature or an inanimate object to be learned and has a first print part provided thereon such that the shape can be visually identified.

In addition, the attachment means has at least one or more perforations regularly or irregularly formed with a predetermined length in the body and the attachment means is an insertion hole, into which the lower portion of the stereoscopic plate is inserted.

Furthermore, the body further includes a second print part formed on the surface thereof so as to decorate the first print part or display the printed name of the shape of the stereoscopic plate.

In addition, the body further includes a learning material, and the learning material has a third print part provided on the surface thereof and displaying an image, which has the same shape and size as the stereoscopic plate, and the unique information of the stereoscopic plate in letters.

Differently from the conventional, the present invention have the effect that the learning ruler allowing three-dimensional play can be used for measuring a length as a ruler that is stationery through the scale printed on a surface thereof in a usual case and for learning while playing through the first to third print parts by separating the stereoscopic plate from the body and three-dimensionally setting the plate on the body in some cases.

### BRIEF DESCRIPTION OF DRAWINGS

FIG. 1 is a view showing the actual image of a learning ruler allowing three-dimensional play according to the present invention.

FIG. 2 is a plan view, in which a stereoscopic plate is coupled to the body of the learning ruler allowing three-dimensional play according to the present invention.

FIG. 3 is an exploded perspective view for FIG. 2, in which the stereoscopic plate is separated from the body, and

FIG. 4 and FIG. 5 show the states of use of the learning ruler allowing three-dimensional play according to the present invention.

### DETAILED DESCRIPTION OF THE INVENTION

Hereinafter, a learning ruler allowing three-dimensional play according to the preferred embodiments of the present invention (hereinafter, referred to as “play ruler”) will be described with reference to the accompanying drawings.

Prior to the description, the stereoscopic plate 120 in the present invention is shown to have the shape of a dinosaur that the infant/adolescents like, but this is merely an example, and it should be noted that preferably an organism such as an animal, a plant and a microorganism as well as inanimate objects such as flags of respective countries, landmarks, images, languages, numbers and symbols, that is, everything that can be used for learning can also be used.

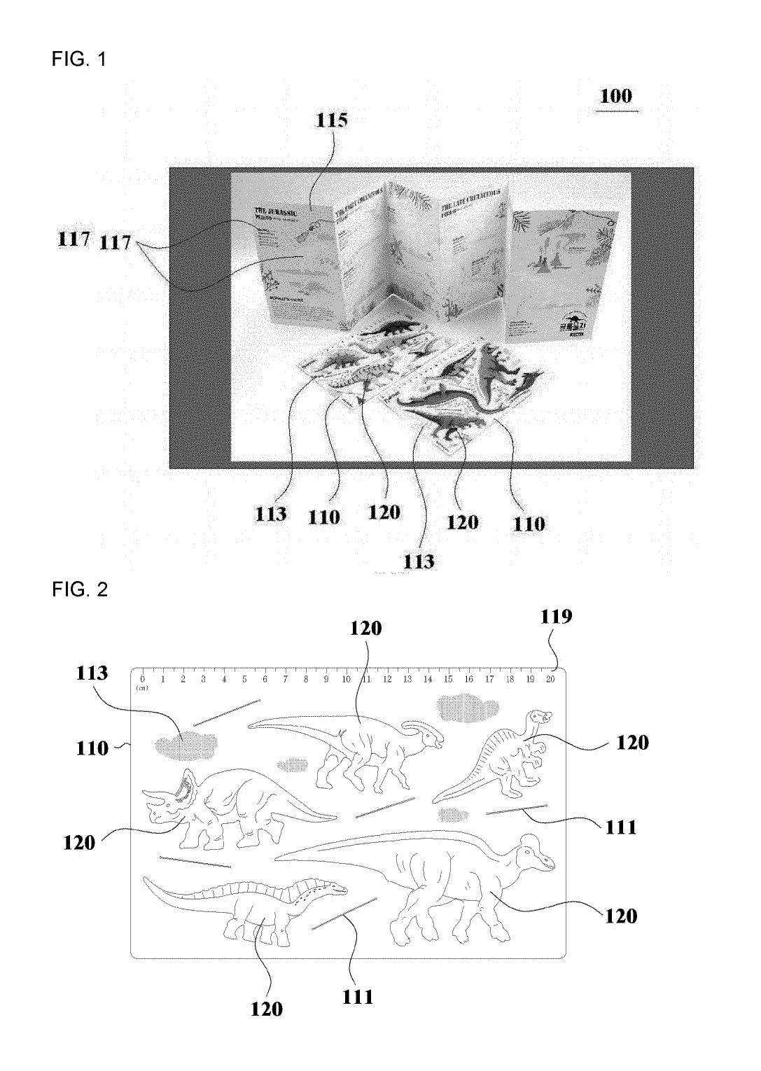

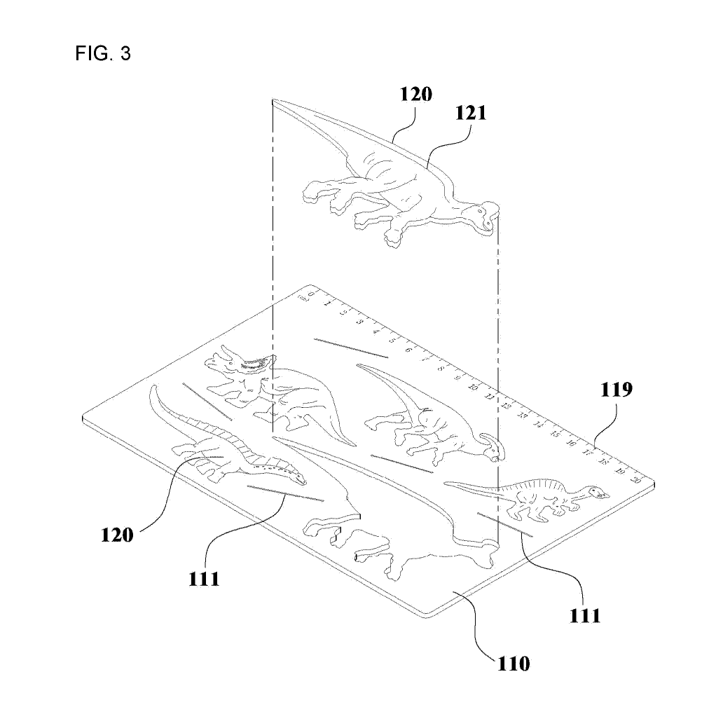

First, as shown in FIG. 1 and FIG. 2, a play ruler 100 according to the present invention mainly comprises a body 110 and a stereoscopic plate 120.

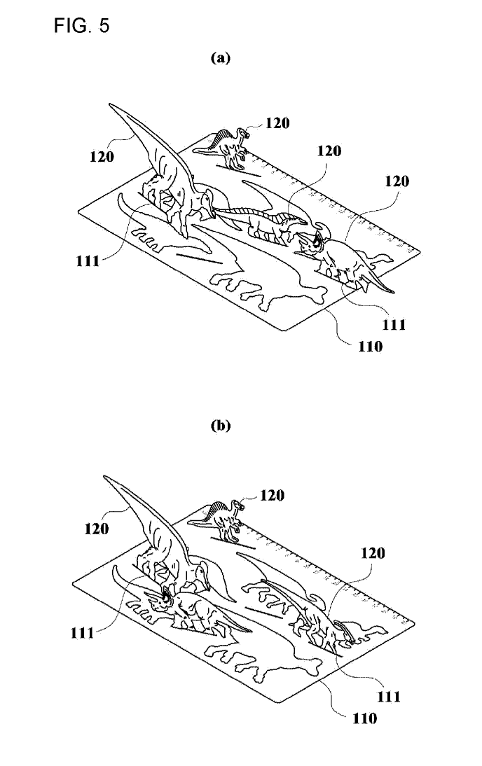

The play ruler is normally used as a ruler that is stationery to measure a length through a scale 119 printed on a surface thereof and has the effect that the play ruler can be used for learning while playing through first to third print parts 121, 113, 117 by separating the stereoscopic plate 120 from the body 110 and three-dimensionally setting the stereoscopic plate 120 on the body 110 in some cases (see FIG. 4).

Explaining more specifically, the body 110 is configured, as shown in FIG. 2, to measure a length and to be used as a learning play board by three-dimensionally placing the stereoscopic plate 120 in some cases as explained hereinafter.

For example, the body 110 is formed to have a rectangular plate shape so as to be easy to use for a person who measures length, and includes one or more scales 119 formed in the vicinity of an edge so as to measure the length in centimeters, inches or the like and an attachment means 111 formed on the top surface thereof so as to three-dimensionally mounting the stereoscopic plate 120.

Herein, the attachment means 111 may be made of a magnet or an adhesive. However, in the present invention, it is preferable that an insertion hole is formed in the surface of the body 100 such that the lower portion of the stereoscopic plate 120 may be inserted into the insertion hole, thereby facilitating the easy use of children.

In addition, at least one or more insertion holes are formed in the body 110 so as to have a “-” shape, wherein a plurality of insertion holes are formed in irregular directions different from each other in accordance with circumstances so as to more three-dimensionally display a plurality of stereoscopic plates 120 when the plurality of stereoscopic plates 120 are mounted on the top surface of the body 110.

Further, the shape of the insertion hole can be formed by selecting one of “x”, “+”, and “*” shapes according to the incision shape of the stereoscopic plate 120.

In addition, the body 110 may further include the second print part 113 provided on the surface thereof so as to decorate the shape of the stereoscopic plate 120 and amplify the visual esthetics thereof, thereby stimulating curiosity as a play, or to display a printed name or the like corresponding to the incision shape of the stereoscopic plate 120 such that a user can easily learn the incision shape of the stereoscopic plate 120 (see FIG. 4).

Herein, the third print part 117 displays an image, which has the same shape as the stereoscopic plate 120, and the unique information on the shape of the stereoscopic plate 120 in letters.

That is, as shown in FIG. 5, the user may be satisfied with the play of separating the stereoscopic plate 120 from the body 110 and mounting the separated stereoscopic plate 120 by the attachment means 111 as well as can use the separated stereoscopic plate 120 like a puzzle piece by matching the separated stereoscopic plate 120 with an image, which is printed on the learning material 115 and has the same shape and size as the stereoscopic plate 120, wherein if the separated stereoscopic plate 120 and the image are matched equally, the second print part 113 allows the user to check the unique information of the stereoscopic plate 120 in more detail (in the case of a dinosaur, survival age or annihilation date, features, etc.) and thus to learn insufficient knowledge.

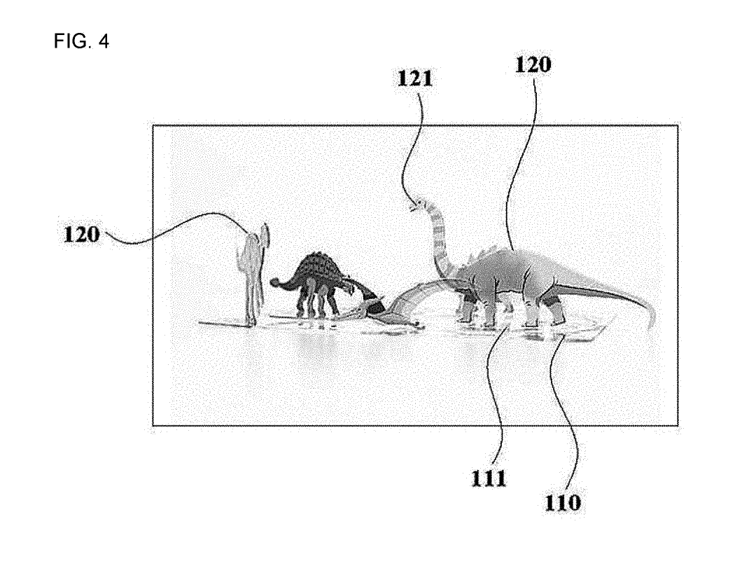

In addition, the stereoscopic plate 120 is, as shown in FIG. 3, is detachably separated from the body 110 such that after being separated, the stereoscopic plate 120 is three-dimensionally attached to the attachment means 111 formed on the body 110 so that the user can perform stereoscopic play.

At this time, it is preferable that the stereoscopic plate 120 is formed in a plate shape and at least one or more of such stereoscopic plates 120 are provided in the shapes of living creatures or inanimate objects by cutting parts of the body 110 so as to be separated from the body 110.

In addition, the first print part 121 can be formed on the surface of the stereoscopic plate 120 such that what the stereoscopic plate 120 is intended to express can be identified with the naked eye, wherein the first print part 121 according to the present invention indicates the shape of a dinosaur.

Therefore, as shown in FIG. 5, the user can insert the stereoscopic plate 120 into any of the plurality of attachment means 111 formed in the body 110 so as to carry out stereoscopic play, thereby preventing boredom.

Further, even if the body 110 and the stereoscopic plate 120 may be formed of paper, the body 110 and the stereoscopic plate 120 are be formed of any one of plastic, acrylic, metal, and wood materials so that the shapes of the body 110 and the stereoscopic plate 120 can be hardly changed even after a long period of use.

The scope of protection of the present invention is not limited to the above-mentioned embodiments, and it may be understood that those skilled in the art will be able to variously modify and change the present invention without departing from the spirit and technical scope of the present invention.

### BRIEF EXPLANATION OF REFERENCE SYMBOLS

| | |
|---|---|
| 100: learning ruler allowing three-dimensional | |
| play according to the present invention | |
| 110: body | 111: attachment means |
| 113: second print part | 115: learning material |
| 117: third print part | 119: scale |
| 120: stereoscopic plate | 121: first print part |

1. A learning ruler allowing three-dimensional play, comprising:
a body (110) having a plate shape and at least one or more scales (119) formed thereon so as to measure a length; and
at least one or more stereoscopic plates (120) formed by cutting parts of the body (110) so as to be detachably attached to the body (110) and to be three-dimensionally set on the top surface of the body by means of attachment means (111) after being separated from the body (10),
wherein the stereoscopic plate (120) is formed to be cut in the shape of at least one of a living creature or an inanimate object to be learned and has a first print part (121) provided thereon such that the shape can be visually identified.

2. The learning ruler allowing three-dimensional play according to claim 1, wherein the attachment means (111) has at least one or more perforations regularly or irregularly formed with a predetermined length in the body (110) and the attachment means (111) is an insertion hole, into which the lower portion of the stereoscopic plate (120) is inserted.

3. The learning ruler allowing three-dimensional play according to claim 1, wherein the body (110) further includes a second print part (113) formed on the surface thereof so as to decorate the first print part (121) or display the printed name of the shape of the stereoscopic plate (120).

4. The learning ruler allowing three-dimensional play according to claim 1, wherein the body (110) further includes a learning material (115) and the learning material (115) has a third print part (117) provided on the surface thereof and displaying an image, which has the same shape and size as the stereoscopic plate (120), and unique information of the stereoscopic plate (120) in letters.
